(19) United States
(12) Patent Application Publication
(10) Pub. No.: US 2016/0196043 A1
(43) Pub. Date: Jul. 7, 2016

(54) METHOD FOR SELECTING CONTENT AND ELECTRONIC DEVICE THEREOF

(71) Applicant: Samsung Electronics Co., Ltd., Gyeonggi-do (KR)

(72) Inventor: Taeyoung Kim, Gyeonggi-do (KR)

(73) Assignee: Samsung Electronics Co., Ltd.

(21) Appl. No.: 14/982,980

(22) Filed: Dec. 29, 2015

(30) Foreign Application Priority Data
Jan. 2, 2015 (KR) 10-2015-0000119

(51) Int. Cl. G06F 3/0484; G06F 3/0485; G06F 3/0482; G06F 3/0486; G06F 3/0488

(52) U.S. Cl. CPC G06F 3/04842; G06F 3/0486; G06F 3/0488; G06F 3/0482; G06F 3/0485

(57) ABSTRACT

A method of operating an electronic device is provided. The method includes displaying checkboxes for respective content, sensing a touch start position and drag of the checkbox, sensing a touch release position of a checkbox of other content, and displaying a selection of content in checkboxes between the touch start position and the touch release position.

### PRIORITY

This application claims priority under 35 U.S.C. §119(a) to a Korean Patent Application filed in the Korean Intellectual Property Office on Jan. 2, 2015 and assigned Ser. No. 10-2015-0000119, the entire content of which is incorporated herein by reference.

### BACKGROUND

1. Field of the Invention

Various embodiments of the present disclosure relate to a device and method for multi selecting content and an electronic device thereof.

2. Description of the Related Art

With the growth of information communication technologies and semiconductor technologies, a variety of electronic devices and multimedia devices provide various multimedia services. For example, the electronic devices are providing various multimedia services such as messenger services, broadcasting services, wireless Internet services, camera services, and music play services.

By applying touch screen technologies, the electronic devices are providing touch based user interfaces so that users may easily and conveniently manage content. For example, the electronic devices can select or edit content displayed on a screen, through a touch based input device.

### SUMMARY

To receive a selection of content or perform an additional function through a touch input scheme, an electronic device receives a touch input. For example, to receive a selection of a plurality of content, the electronic device has to receive a plurality of touch inputs from a user. This can cause excessive time consumption and inconvenience in managing the plurality of content.

An aspect of the present disclosure provides a method for multi selecting content in a touch based input device and an electronic device thereof.

An aspect of the present disclosure provides a method for multi selecting content through a drag and an electronic device thereof.

According to an aspect of the present disclosure, an operating method of an electronic device includes displaying checkboxes for respective content, sensing a touch start position and drag of the checkbox, sensing a touch release position of a checkbox of other content, and displaying a selection of content in checkboxes between a touch start position and a touch release position.

According to an aspect of the present disclosure, an electronic device includes a display, and at least one processor operatively connected to the display. The processor may control the display of checkboxes for respective content, sense a touch start position and drag of the checkbox, sense a touch release position of a checkbox of other content, and display a selection of content in checkboxes between a touch start position and a touch release position.

### BRIEF DESCRIPTION OF THE DRAWINGS

The above and other aspects, features and advantages of the present disclosure will become more apparent from the following detailed description when taken in conjunction with the accompanying drawings, in which:

FIG. 1 is a block diagram of an electronic device according to an embodiment of the present disclosure;

FIG. 2 illustrates a flowchart of a method for multi selecting content according to an embodiment of the present disclosure;

FIG. 3 illustrates a flowchart of a method for multi selecting content according to an embodiment of the present disclosure;

FIG. 4A to FIG. 4B illustrate screen shots for multi selecting content according to an embodiment of the present disclosure; FIG. 5 illustrates a flowchart of a method for multi selecting content according to an embodiment of the present disclosure;

FIG. 6A and FIG. 6B illustrate screen shots for multi selecting content according to an embodiment of the present disclosure;

FIG. 7 illustrates a flowchart of a method for multi selecting content according to an embodiment of the present disclosure;

FIG. 8A to FIG. 8C illustrate screen shots for multi selecting content according to an embodiment of the present disclosure;

FIG. 9 illustrates a flowchart of a method for multi selecting content according to an embodiment of the present disclosure; and FIG. 10A to FIG. 10C illustrate screen shots for multi selecting content according to an embodiment of the present disclosure.

### DETAILED DESCRIPTION

Particular embodiments of the present disclosure will be described herein below with reference to the accompanying drawings. In the following description, detailed descriptions of well-known functions or configurations will be omitted since they would unnecessarily obscure the subject matter of the present disclosure. Also, the terms used herein are defined according to the functions of the present disclosure. Thus, the terms may vary depending on users' or operators' intentions or practices. Therefore, the terms used herein should be understood based on the descriptions made herein.

An electronic device according to an embodiment of the present disclosure may be a device which is equipped with a communication function. For example, the electronic device may include at least one of a smartphone, a tablet personal computer (PC), a mobile phone, a video phone, an electronic book reader, a desktop PC, a laptop PC, a netbook computer, a Personal Digital Assistant (PDA), a Portable Multimedia Player (PMP), an MP3 player, a mobile medical machine, a camera, or a wearable device (e.g., a head-mounted-device (HMD) such as electronic glasses, electronic clothing, an electronic bracelet, an electronic necklace, an electronic appccessory, electronic tattoos, or a smartwatch).

According to an embodiment of the present disclosure, the electronic device may be a smart home appliance which is equipped with a communication function. For example, the smart home appliance may include at least one of a television, a Digital Video Disk (DVD) player, a stereo, a refrigerator, an air conditioner, a cleaner, an oven, a microwave oven, a washing machine, an air cleaner, a set-top box, a TV box (for example, Samsung HomeSync™, Apple TV™, or Goggle TV™), a game console, an electronic dictionary, an electronic key, a camcorder, or an electronic album.

According to an embodiment of the present disclosure, the electronic device may include at least one of various medical machines (for example, Magnetic Resonance Angiography (MRA), Magnetic Resonance Imaging (MRI), Computerized Tomography (CT), a tomograph, an ultrasound machine, and the like), a navigation device, a Global Positioning System (GPS) receiver, an Event Data Recorder (EDR), a Flight Data Recorder (FDR), an automotive infotainment device, electronic equipment for ships (for example, navigation equipment for ships, a gyro compass, and the like), avionics, a security device, a head unit for vehicles, an industrial or home robot, an automatic teller machine (ATM) of a financial institution, or point of sales (POS) terminal of a store.

According to an embodiment of the present disclosure, the electronic device may include at least one of a part of furniture or a building, a structure equipped with a communication function, an electronic board, an electronic signature receiving device, a projector, and various measurement devices (for example, water, power, gas, or radio waves measurement devices). The electronic device according to an embodiment of the present disclosure may be one or a combination of one or more of the above-mentioned devices. In addition, the electronic device according to an embodiment of the present disclosure may be a flexible device. In addition, it is obvious to an ordinary skilled person in the related art that the electronic device according to an embodiment of the present disclosure is not limited to the above-mentioned devices.

Hereinafter, an electronic device according to an embodiment of the present disclosure will be explained with reference to the accompanying drawings. The term “user” may refer to a person who uses the electronic device or a device which uses the electronic device (for example, an artificial intelligence electronic device).

As presented below, the present disclosure describes a technology for multi selecting content in an electronic device.

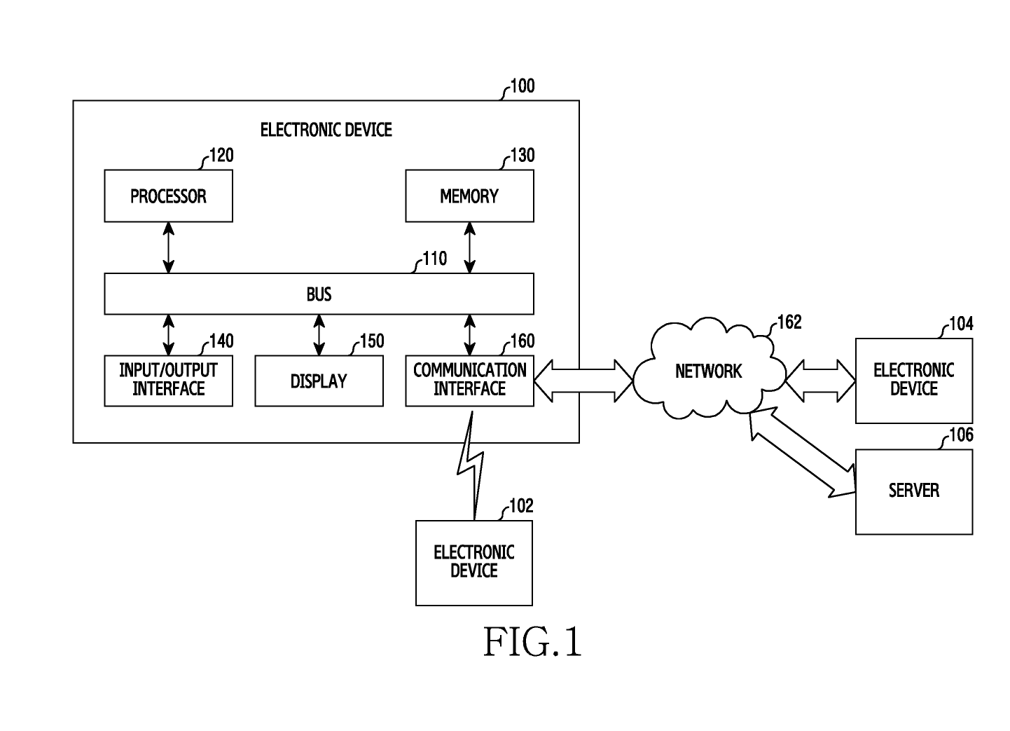

FIG. 1 is a block diagram of an electronic device according to an embodiment of the present disclosure.

Referring to FIG. 1, the electronic device 100 includes a bus 110, a processor 120, a memory 130, an input/output interface 140, a display 150, and a communication interface 160. In some particular embodiments, the electronic device 100 may omit at least one of the aforementioned constituent elements or additionally have other constituent elements.

The bus 110 is a circuit connecting the aforementioned constituent elements (e.g., the processor 120, the memory 130, the input/output interface 140, the display 150 or the communication interface 160, etc.) with one another, and forwarding communication (e.g., a control message) between the aforementioned constituent elements.

The processor 120 may include one or more of a Central Processing Unit (CPU), an Application Processor (AP), or a Communication Processor (CP). The processor 120 may, for example, execute operation or data processing for control and/or communication of at least one other constituent element of the electronic device 100.

According to an embodiment of the present disclosure, the processor 120 may control to display checkboxes for respective content, sense a touch start position and drag of the displayed checkbox, sense a touch release position of a checkbox of other content, and display a selection of content of checkboxes between a touch start position and a touch release position. The content may include at least one of a text, an icon, a photo, and a thumbnail image. The checkbox of the content may be used as an indicator for selecting the corresponding content and displaying of the content selection to a user.

According to an embodiment of the present disclosure, after displaying checkboxes for respective content, the processor 120 may activate a multi selection mode. For example, by sensing a selection of a specific icon, the processor 120 may activate the multi selection mode. In the state in which the multi selection mode is activated, if the specific icon is selected again by a touch, the processor 120 may inactivate the multi selection mode. For another example, if a touch on a checkbox displayed for content is held for a threshold time or more, the processor 120 may activate the multi selection mode.

According to an embodiment of the present disclosure, after sensing a touch start position and drag of a checkbox, the processor 120 may sense holding of the drag in a set edge region. The edge region may be a region that is set to scroll up or down and show content unseen on a screen. The edge region may be positioned at a lower side of the screen, but may be, without being limited to this, arranged in at least one of an upper side of the screen, a left side thereof or a right side thereof. The processor 120 may scroll content in accordance with the holding of the drag in the edge region. The processor 120 may determine a scroll direction of the content in accordance with a position of the edge region.

According to an embodiment of the present disclosure, after sensing a touch start position and drag of a checkbox, the processor 120 may sense other drag and scroll content. For example, in a state in which a user holds a drag starting from a checkbox of content with one hand, if he/she performs an additional drag operation with the other hand, the processor 120 may scroll content in accordance with the additional drag operation.

According to an embodiment of the present disclosure, the processor 120 may display a selection of content in checkboxes corresponding to a line connecting a touch start position and a touch release position.

According to an embodiment of the present disclosure, the processor 120 may determine a set region having a diagonal line connecting a touch start position and a touch release position, and display a selection of content in checkboxes included in the set region.

According to an embodiment of the present disclosure, the memory 130 may include a volatile and/or nonvolatile memory and may store an instruction or data related to at least one other constituent element of the electronic device 100. According to an embodiment of the present disclosure, the memory 130 may store software and/or programs. For example, the programs may include a kernel, a middleware, an Application Programming Interface (API) or an application, etc. At least some of the kernel, the middleware, or the API may be called an Operating System (OS).

The input/output interface 140 may play a role in an interface capable of forwarding an instruction or data, which is inputted from a user or other external device, to other constituent elements of the electronic device 100. The input/output interface 140 may output an instruction or data received from other constituent element of the electronic device 100, to the user or other external device.

The display 150 may, for example, include a Liquid Crystal Display (LCD), a

Light Emitting Diode (LED) display, an Organic Light Emitting Diode (OLED) display, or a MicroElectroMechanical Systems (MEMS) display, or an electronic paper display. The display 150 may, for example, display various content (e.g., a text, an image, a video, an icon, or a symbol, etc.) to a user. The display 150 may include a touch screen, and may receive a touch, gesture, proximity, or hovering input that makes use of an electronic pencil or a part of the body of the user as an input device.

According to an embodiment of the present disclosure, the display 150 may display checkboxes for respective content. The display 150 may display an interface according to multi selecting of content. The display 150 may display an icon for a multi selection mode.

The communication interface 160 enables communication between the electronic device 100 and external devices (such as the electronic device 104 or the server 106). For example, the communication interface 160 is connected to a network 162 via wireless communication or wired communication to communicate with the external devices. The wireless communication may include at least one of Wireless Fidelity (WiFi), Bluetooth (BT), Near Field Communication (NFC), Global Positioning System (GPS), or cellular communication (for example: LTE, LTE-A, CDMA, WCDMA, UMTS, WiBro, GSM, and the like). The wired communication may include at least one of a Universal Serial Bus (USB), a High Definition Multimedia Interface (HDMI), a Recommended Standard 232 (RS-232), or a Plain Old Telephone Service (POTS).

According to an embodiment of the present disclosure, the network 162 may be a telecommunications network. The telecommunications network may include at least one of a computer network, the Internet, Internet of Things (IoT), or a telephone network.

Each of the first external electronic device 102 and the second external electronic device 104 may be the same kind of electronic device as the electronic device 100 or a different kind of device. According to an embodiment of the present disclosure, the server 106 may include a group of one or more servers. Furthermore, all or a part of the operations executed in the electronic device 100 may be executed in another electronic device or a plurality of other electronic devices, such as the electronic devices 102, 104 or the server 106. When the electronic device 100 performs a certain function or service automatically or in response to a request, the electronic device 100 may request another device 102, 104 or the server 106 to perform at least some function related to the certain function or service additionally or instead of executing the function or service by itself. The electronic devices 102, 104 or the server 106 may execute the requested function or additional function, and transmit the result to the electronic device 100. The electronic device 100 may process the received result as it is or additionally, and provide the requested function or service. To achieve this functionality, cloud computing, distributed computing, or client-server computing technology may be used.

An electronic device according to an embodiment of the present disclosure includes a display 150, and at least one processor 120 operatively connected to the display 150. The processor 120 may control to display checkboxes for respective content, sense a touch start position and drag of the checkbox, sense a touch release position of a checkbox of other content, and display a selection of content in checkboxes between a touch start position and a touch release position.

According to an embodiment of the present disclosure, after sensing the touch start position and drag of the checkbox, the processor 120 may sense holding of the drag in a set edge region, and scroll content in accordance with the holding of the drag.

According to an embodiment of the present disclosure, the processor 120 may determine a scroll direction of the content in accordance with a position of the edge region.

According to an embodiment of the present disclosure, after sensing the touch start position and drag of the checkbox, the processor 120 may sense another drag, and scroll content in accordance with the other drag.

According to an embodiment of the present disclosure, the processor 120 may display the selection of the content in checkboxes corresponding to a line connecting the touch start position and the touch release position.

According to an embodiment of the present disclosure, the processor 120 may determine a set region having a diagonal line connecting the touch start position and the touch release position, and display the selection of the content in checkboxes comprised in the set region.

According to an embodiment of the present disclosure, after displaying the checkboxes for the respective content, the processor may activate a multi selection mode.

According to an embodiment of the present disclosure, the processor 120 may sense the selection of an icon and activate the multi selection mode.

According to an embodiment of the present disclosure, the processor 120 may sense a touch on a checkbox corresponding to content for a threshold time or more and activate the multi selection mode.

According to an embodiment of the present disclosure, the processor 120 may inactivate the multi selection mode.

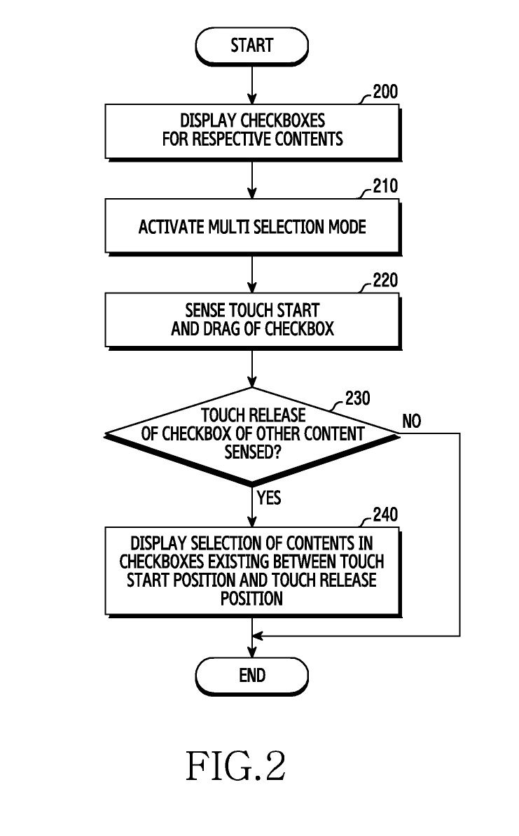

FIG. 2 illustrates a flowchart of a method for multi selecting content according to an embodiment of the present disclosure.

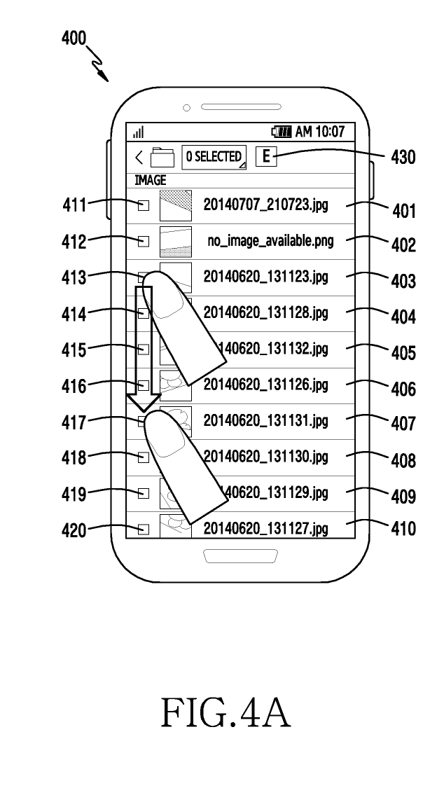

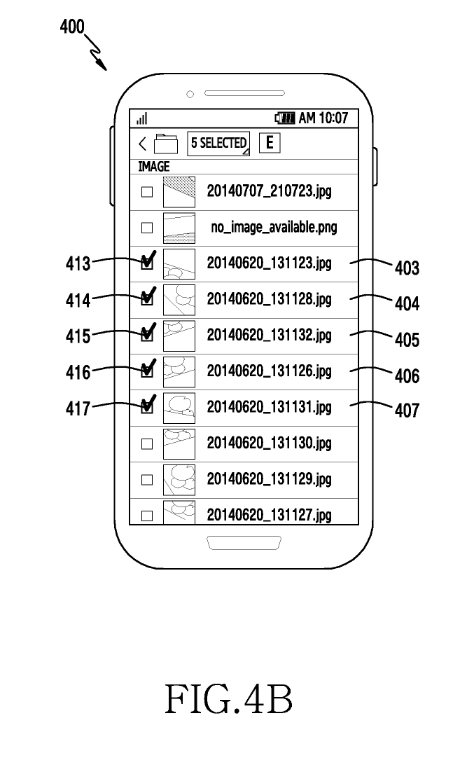

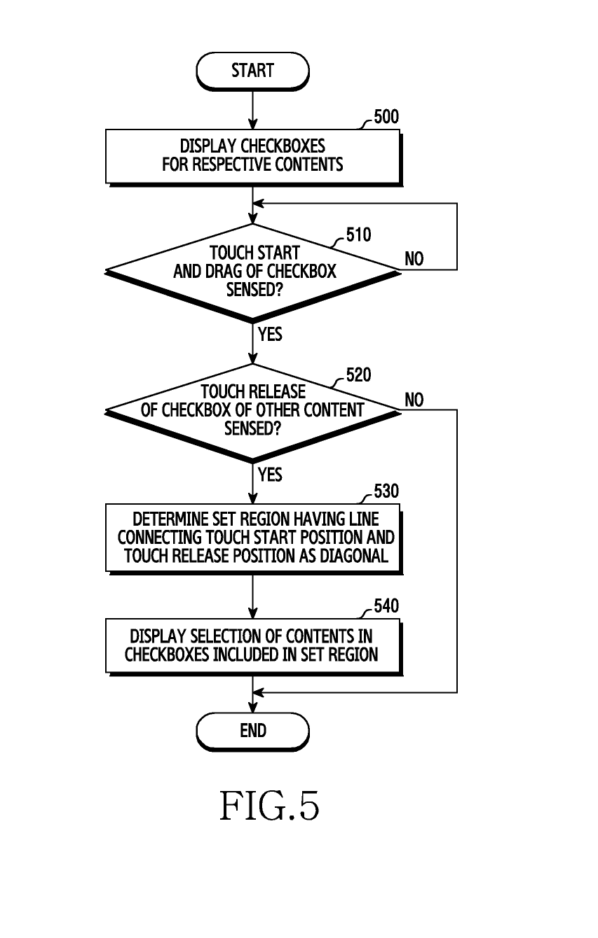

Referring to FIG. 2, in step 200, an electronic device (e.g., the electronic device 100) displays checkboxes for respective content. For example, as in FIG. 4A, an electronic device 400 displays checkboxes 411 to 420 for a plurality of content 401 to 410 on a screen. The content includes at least one of a text, an icon, a photo, and a thumbnail image. The checkboxes for the respective content may be used as indicators for notifying a user that the corresponding content is selected.

In step 210, the electronic device activates a multi selection mode. For example, as in FIG. 4A, the electronic device 400 senses a selection of an icon 430 and activates the multi selection mode. According to an embodiment of the present disclosure, in a state in which the icon 430 has been selected (i.e., in a multi selection mode activation state), if the icon 430 is selected once again by a user, the electronic device 400 may inactivate the multi selection mode. If a touch on a checkbox of content is held for a threshold time or more, the electronic device 400 may activate the multi selection mode. There are without limitation, various methods for activating the multi selection mode.

In step 220, the electronic device senses a touch start position and drag of the checkbox. For example, as in FIG. 4A, the electronic device 400 senses a touch start psition and drag of a checkbox 413 of content 403 displayed on a screen.

In step 230, the electronic device determines if a touch release position of a checkbox of other content is sensed. For example, as in FIG. 4A, the electronic device 400 senses a touch release position of a checkbox 417 of content 407 displayed on the screen.

Upon failing to sense the touch release position of the checkbox of the other content, the electronic device may terminate the present procedure. For example, if sensing a touch release position in a region other than the checkboxes of the content, the electronic device may terminate the present procedure.

If sensing the touch release position of the checkbox of the other content, in step 240, the electronic device displays a selection of content in checkboxes between a touch start position and a touch release position. For example, as in FIG. 4B, the electronic device 400 displays a selection of corresponding content 403 to 407 in checkboxes 413 to 417 corresponding to a straight line connecting a touch start position of a drag and a touch release position thereof.

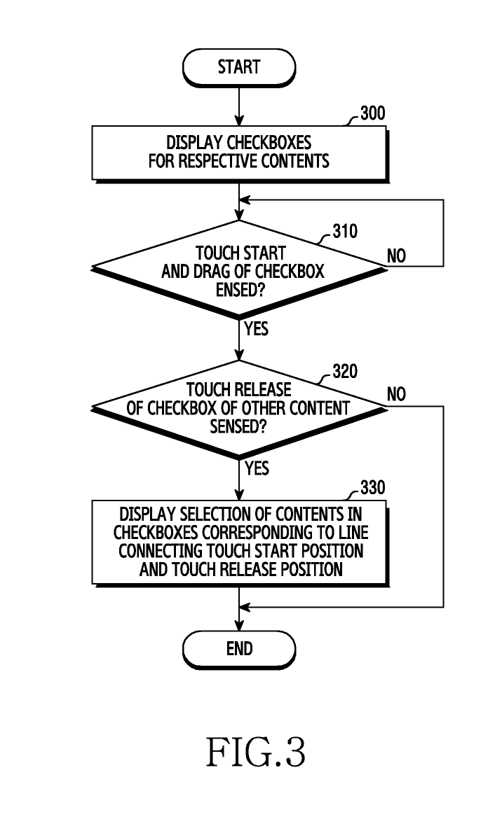

FIG. 3 illustrates a flowchart of a method for multi selecting content according to an embodiment of the present disclosure of the present disclosure.

Referring to FIG. 3, in step 300, an electronic device 100 displays checkboxes for respective content. For example, as in FIG. 4A, an electronic device 400 displays checkboxes 411 to 420 for a plurality of content 401 to 410 on a screen. Here, the content includes at least one of a text, an icon, a photo, and a thumbnail image. The checkboxes for the content may be used as indicators for notifying a user that the corresponding content is selected.

According to an embodiment of the present disclosure, after displaying the checkboxes for the respective content, the electronic device 400 may activate a multi selection mode. The multi selection mode may include a mode for performing a function of concurrently selecting a plurality of content. For example, by sensing the selection of an icon 430, the electronic device 400 may activate the multi selection mode. If a touch on a checkbox of content is held for a threshold time or more, the electronic device 400 may activate the multi selection mode. There are without limitation, various methods for activating the multi selection mode.

In step 310, the electronic device determines if a touch start position and drag of the checkbox is sensed. For example, as in FIG. 4A, the electronic device 400 determines if a touch start position and drag of a checkbox 413 of content 403 displayed on a screen is sensed.

Upon sensing the touch start position and drag of the checkbox, in step 320, the electronic device determines if a touch release position of a checkbox corresponding to other content is sensed. For example, as in FIG. 4A, the electronic device 400 determines if a touch release position of a checkbox 417 of content 407 displayed on the screen is sensed.

Upon failing to sense the touch release position of the checkbox of the other content, for example, if sensing a touch release position in a region other than the checkboxes of the content, the electronic device may terminate the present procedure.

If sensing the touch release position of the checkbox of the other content, in step 330, the electronic device displays a selection of content in checkboxes corresponding to a line connecting a touch start position and a touch release position. For example, as in

FIG. 4B, the electronic device 400 displays a selection of content 403 to 407 in checkboxes 413 to 417 corresponding to a straight line connecting a touch start position of a drag and a touch release position thereof.

FIG. 5 illustrates a flowchart of a method for multi selecting content according to an embodiment of the present disclosure.

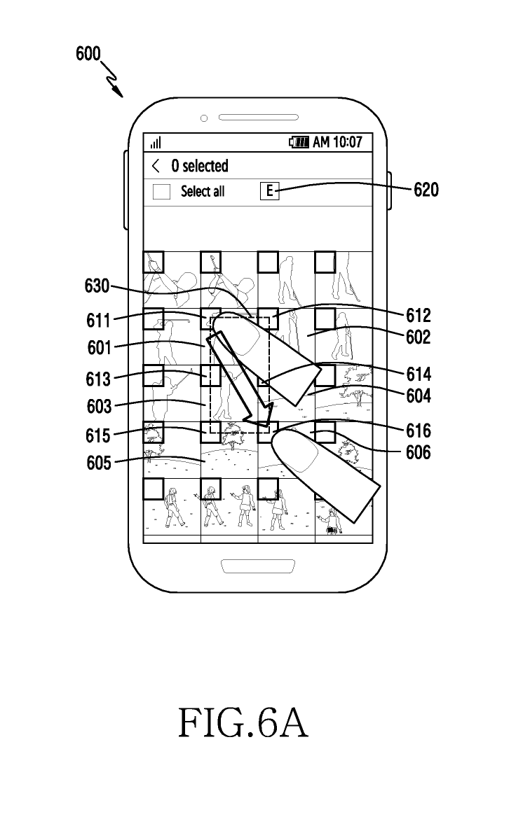

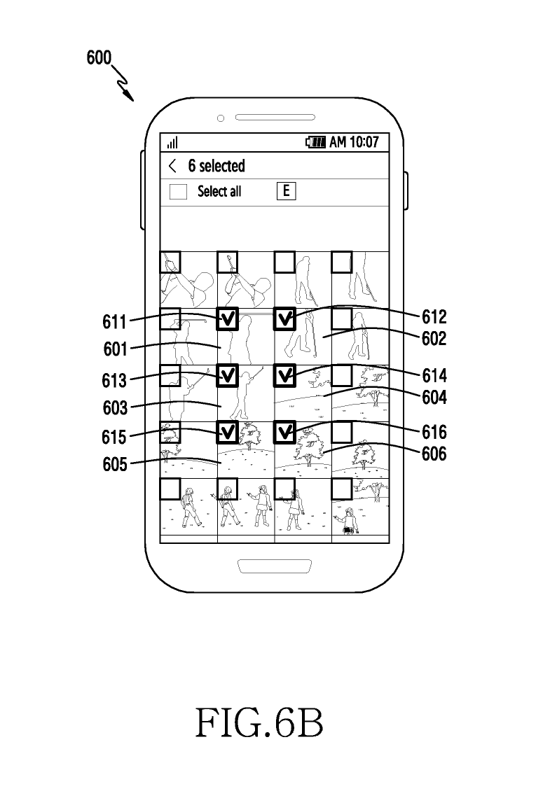

Referring to FIG. 5, in step 500, an electronic device (e.g., the electronic device 100) displays checkboxes for respective content. For example, as in FIG. 6A, an electronic device 600 displays checkboxes 611 to 616, for a plurality of content 601 to 606 on a screen. The content includes at least one of a text, an icon, a photo, and a thumbnail image. The checkboxes for the content may be used as indicators for notifying a user that the corresponding content is selected.

According to an embodiment of the present disclosure, after displaying the checkboxes for the respective content, the electronic device 600 may activate a multi selection mode. The multi selection mode may include a mode for performing a function of concurrently selecting a plurality of content. For example, if the selection of an icon 620 is sensed, the electronic device 600 may activate the multi selection mode. If a touch on a checkbox of content is held for a threshold time or more, the electronic device 600 may activate the multi selection mode. There are without limitation, various methods for activating the multi selection mode.

In step 510, the electronic device determines if a touch start position and drag of the checkbox is sensed. For example, as in FIG. 6A, the electronic device 600 determines if a touch start position and drag of a checkbox 611 of content 601 displayed on a screen is sensed.

If the touch start position and drag of the checkbox is not sensed, the electronic device again performs step 510 of determining if the touch start position and drag is sensed.

If sensing the touch start position and drag of the checkbox, in step 520, the electronic device 600 determines if a touch release position of a checkbox of other content is sensed. For example, as in FIG. 6A, the electronic device 600 determines if a touch release position of a checkbox 616 of content 606 displayed on the screen is sensed.

If failing to sense the touch release position of the checkbox of the other content, for example, if sensing a touch release position in a region other than the checkboxes of the content, the electronic device may terminate the present procedure.

If sensing the touch release position of the checkbox of the other content, in step 530, the electronic device determines a set region having a diagonal line connecting a touch start position and a touch release position. For example, as in FIG. 6A, the electronic device 600 determines a set region 630 having a diagonal line connecting a touch start position of a drag and a touch release position thereof.

In step 540, the electronic device displays a selection of content in checkboxes included in the set region. For example, as in FIG. 6B, the electronic device 600 displays a selection of content 601, 602, 603, 604, 605, 606 in checkboxes 611, 612, 613, 614, 615, 616 corresponding to a set region having a diagonal line connecting a touch start position of a drag and a touch release position thereof.

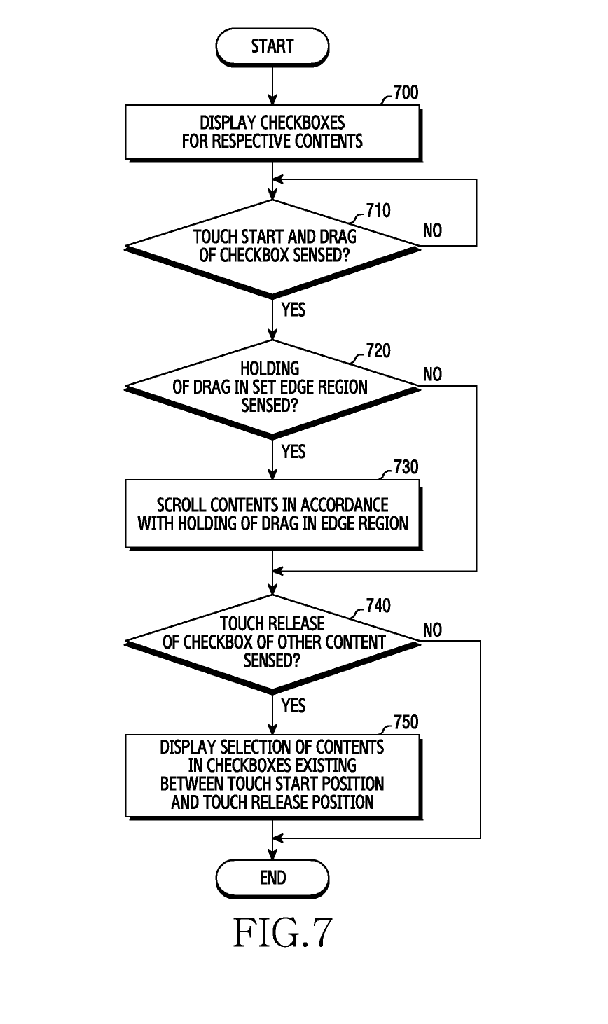

FIG. 7 illustrates a procedure of a method for multi selecting content according to an embodiment of the present disclosure.

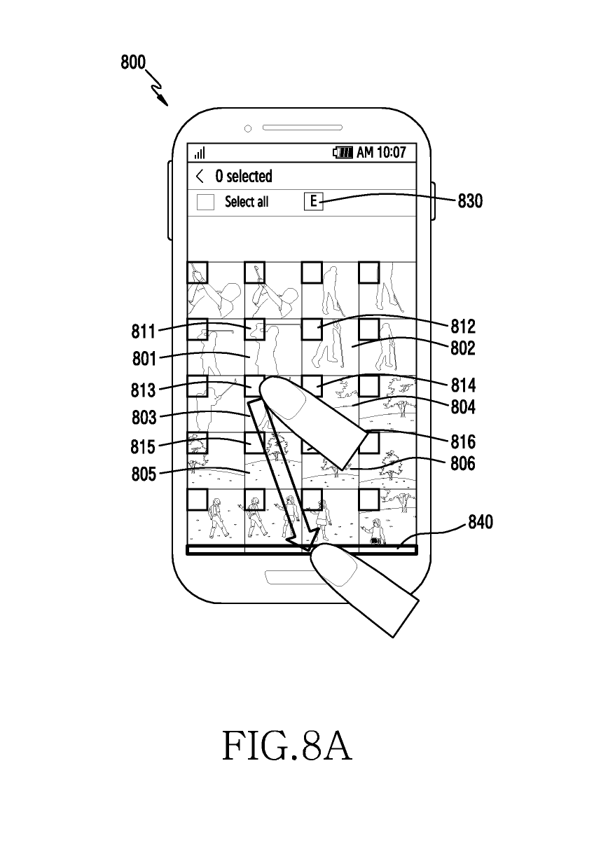

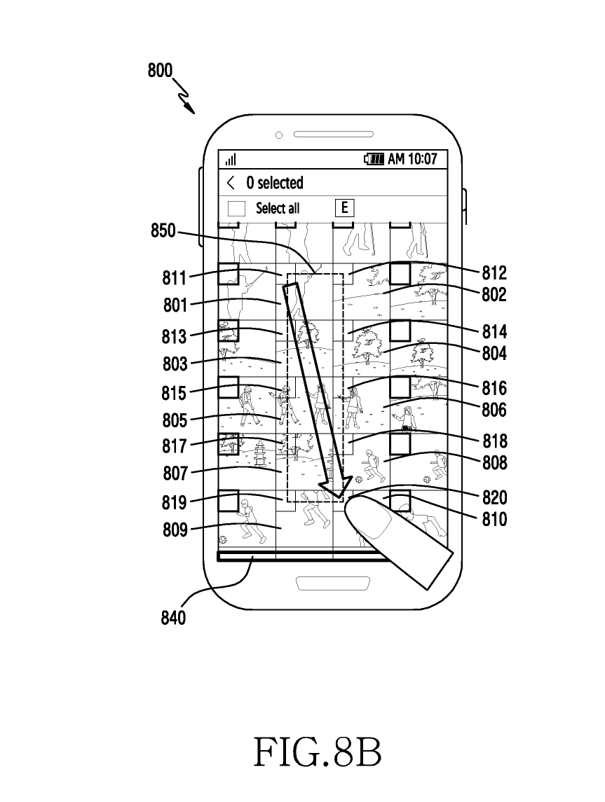

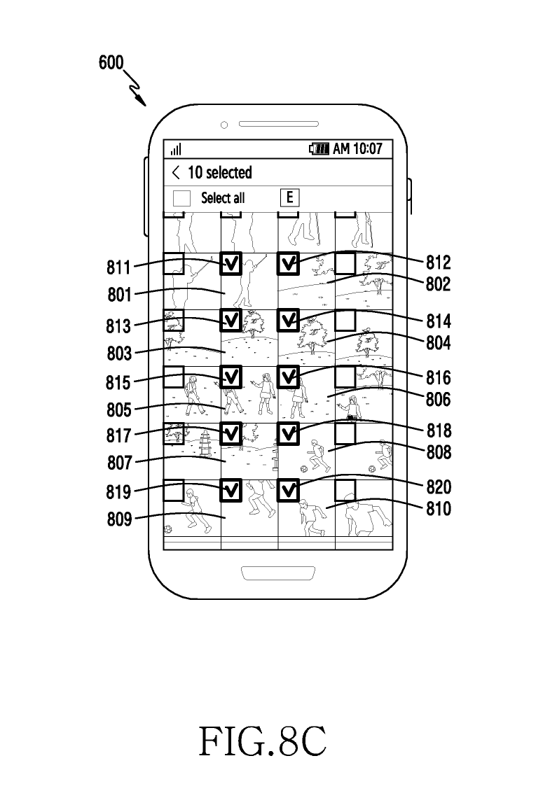

Referring to FIG. 7, in step 700, an electronic device (e.g., the electronic device 100) displays checkboxes for respective content. For example, as in FIG. 8A, an electronic device 800 displays checkboxes 811, 812, 813, 814, 815, 816 for a plurality of content 801, 802, 803, 804, 805, 806 on a screen. The content includes at least one of a text, an icon, a photo, and a thumbnail image. The checkboxes for the content may be used as indicators for notifying a user that the corresponding content is selected.

According to an embodiment of the present disclosure, after displaying the checkboxes for the respective content, the electronic device 800 may activate a multi selection mode. The multi selection mode may include a mode for performing a function of concurrently selecting a plurality of content. For example, by sensing the selection of an icon 830, the electronic device 800 may activate the multi selection mode. If a touch on a checkbox of content is held for a threshold time or more, the electronic device 800 may activate the multi selection mode. There are without limitation various methods for activating the multi selection mode.

In step 710, the electronic device determines if a touch start position and drag of the checkbox is sensed. For example, as in FIG. 8A, the electronic device 800 determines if a touch start position and drag of a checkbox 811 corresponding to content 803 displayed on a screen is sensed.

Upon sensing the touch start position and drag of the checkbox, in step 720, the electronic device determines if the drag is held in a set edge region. The edge region may be a region that is set to scroll up or down and show content unseen on a screen as in FIG. 8A. The edge region 840 is positioned at a lower side of the screen, but may be without limitation, arranged in at least one of an upper side of the screen, a left side thereof or a right side thereof.

Upon failing to sense the holding of the drag in the edge region, the electronic device jumps to step 740.

If the drag is held in the edge region, in step 730, the electronic device scrolls content during a time for which the drag is held in the edge region. For example, if the drag is held in the edge region 840 as in FIG. 8A, the electronic device 800 scrolls up and shows additional content 807, 808, 809, 810, etc. during the time for which the drag is held as in FIG. 8B.

According to an embodiment of the present disclosure, a description has been made in which the edge region is arranged at the lower side of the screen, and the content is scrolled up and displayed during the time for which the drag is held in the edge region, but this does not limit the scope and spirit of the present disclosure. For example, if the edge region is arranged at an upper side of the screen, a left side thereof, or a right side thereof, a scroll direction may be set in accordance with a position of the edge region.

In step 740, the electronic device determines if a touch release position of a checkbox of other content is sensed. For example, as in FIG. 8B, the electronic device 800 determines whether a touch release position of checkbox 820 corresponding to other content 810 displayed on the screen is sensed.

Upon failing to sense the touch release position of the checkbox of the other content, for example, if sensing a touch release position in a region other than the checkboxes of the content, the electronic device may terminate the present procedure.

If sensing the touch release position of the checkbox of the other content, in step 750, the electronic device displays a selection of content in checkboxes between a touch start position and a touch release position. For example, as in FIG. 8B, the electronic device 800 determines a set region 850 having a diagonal line connecting a touch start position and a touch release position. In FIG. 8C, the electronic device 800 displays a selection of respective content 801, 802, 803, 804, 805, 806, 807, 808, 809 and 810 in checkboxes 811, 812, 813, 814, 815, 816, 817, 818, 819 and 820 corresponding to the set region 850.

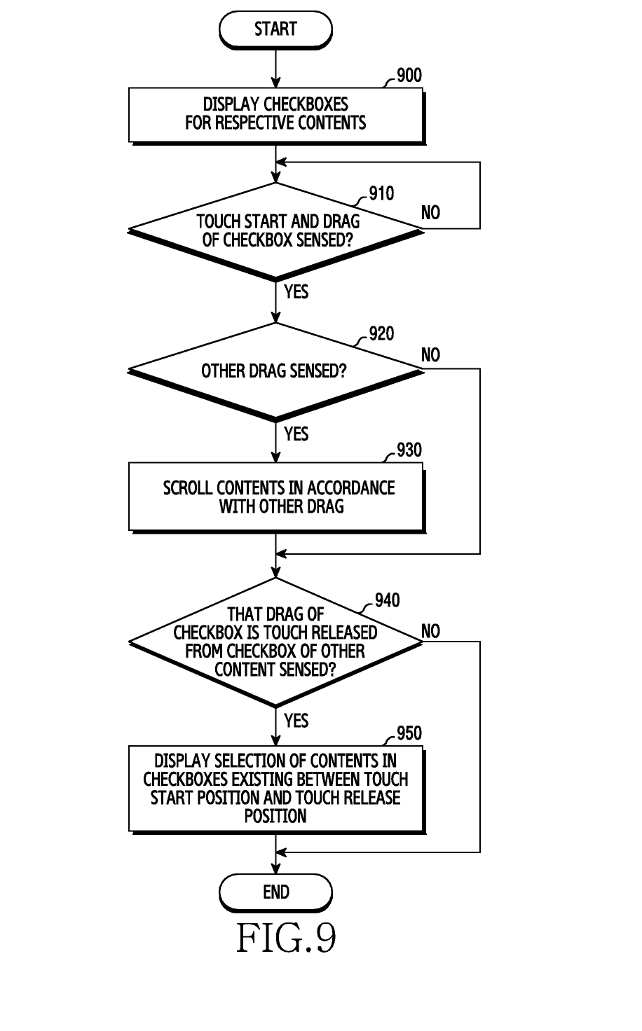

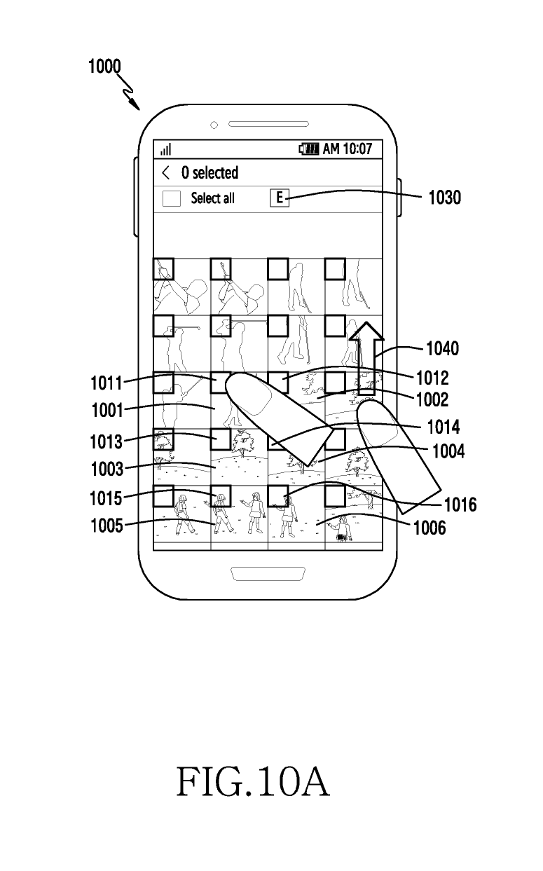

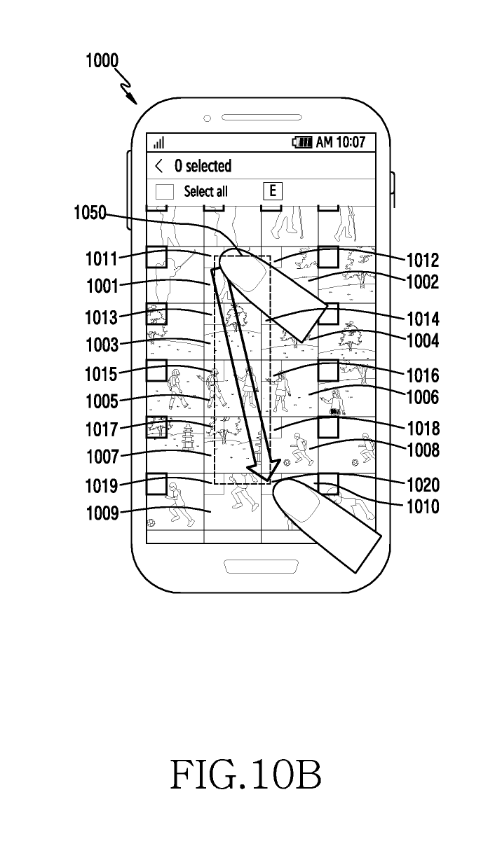

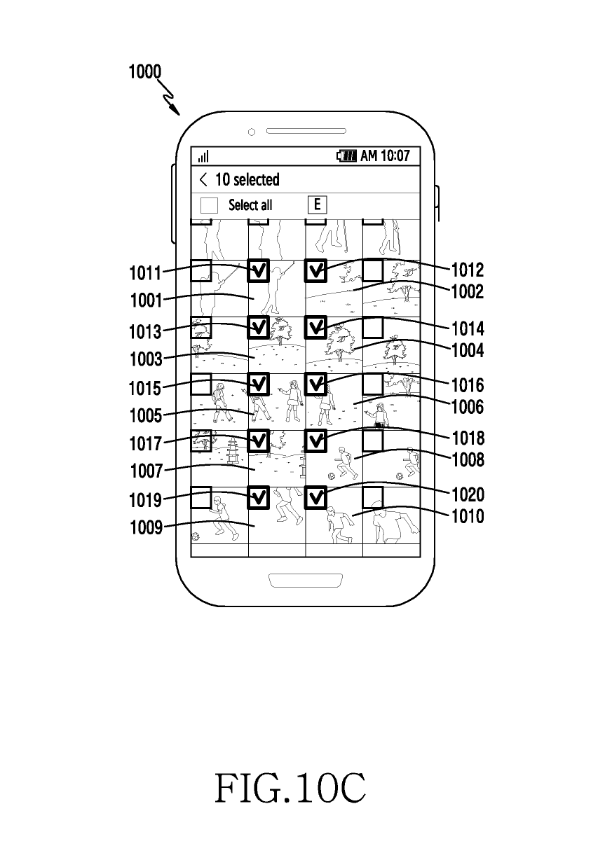

FIG. 9 illustrates a flowchart of a method for multi selecting content according to an embodiment of the present disclosure.

Referring to FIG. 9, in step 900, an electronic device 100 displays checkboxes for respective content. For example, as in FIG. 10A, an electronic device 1000 displays checkboxes 1011, 1012, 1013, 1014, 1015, 1016, etc. for a plurality of content 1001, 1002, 1003, 1004, 1005, 1006, etc. on a screen. The content includes at least one of a text, an icon, a photo, and a thumbnail image. The checkboxes for the content may be used as indicators for notifying a user that the corresponding content is selected.

According to an embodiment of the present disclosure, after displaying the checkboxes for the respective content, the electronic device may activate a multi selection mode. The multi selection mode may include a mode for performing a function of concurrently selecting a plurality of content. For example, if sensing the selection of an icon 1030, the electronic device 1000 activates the multi selection mode. If a touch on a checkbox of content is held for a threshold time or more, the electronic device 1000 activates the multi selection mode. There are without limitation, various methods for activating the multi selection mode.

In step 910, the electronic device determines if a touch start position and drag of the checkbox is sensed. For example, as in FIG. 10A, the electronic device 1000 determines if a touch start position and drag of a checkbox 1011 corresponding to content 1001 displayed on a screen is sensed.

Upon sensing the touch start position and drag of the checkbox, in step 920, the electronic device determines whether another drag is sensed. For example, as in FIG. 10A, in a state in which a user holds a drag starting from a checkbox of content with one hand, the electronic device determines whether the user performs an additional drag 1040 with the other hand.

If failing to sense the other drag, the electronic device jumps to step 940. If sensing the other drag, in step 930, the electronic device scrolls content in accordance with the other drag. For example, if the electronic device 1000 senses the other drag 1040 in the down to up direction as in FIG. 10A, the electronic device 1000 scrolls up and shows additional content 1007, 1008, 1009, 1010, etc. in accordance with the other drag as in FIG. 10B.

According to an embodiment of the present disclosure, a description has been provided in which the user performs the additional drag operation with the other hand and the content is scrolled up and displayed, but this does not intend to limit the scope and spirit of the present disclosure. For example, in the case that the user performs drags in various directions (e.g., the up to down direction, etc.) with one hand, a scroll direction may be set in accordance with the drag direction.

In step 940, the electronic device determines if it is sensed that the drag of the checkbox is touch released from a checkbox of other content. For example, as in FIG. 10B, the electronic device 1000 determines if a touch release of a checkbox 1020 corresponding to another content 1010 displayed on a screen is sensed.

If it is not sensed that the drag of the checkbox is touch released from the checkbox of the other content, for example, if it is sensed that the drag of the checkbox is touch released from a region other than the checkbox of the content, the electronic device may terminate the present procedure.

If it is sensed that the drag of the checkbox is touch released from the checkbox of the other content, in step 950, the electronic device displays a selection of content in checkboxes between a touch start position and a touch release position. For example, in FIG. 10B, the electronic device 1000 determines a set region 1050 having a diagonal line connecting a touch start position and a touch release position. Also, as in FIG. 10C, the electronic device 1000 displays a selection of respective content 1001, 1002, 1003, 1004, 1005, 1006, 1007, 1008, 1009 and 1010 in checkboxes 1011, 1012, 1013, 1014, 1015, 1016, 1017, 1018, 1019 and 1020 corresponding to the set region 1050.

An operating method of an electronic device according to an embodiment of the present disclosure may include displaying checkboxes for respective content, sensing a touch start position and drag of the checkbox, sensing a touch release position of a checkbox of other content, and displaying a selection of content in checkboxes between the touch start position and the touch release position.

According to an embodiment of the present disclosure, after sensing the touch start position and drag of the checkbox, the method may further include sensing a hold of the drag in a set edge region, and scrolling content in accordance with the holding of the drag.

According to an embodiment of the present disclosure, scrolling the content in accordance with the holding of the drag includes determining a scroll direction of the content in accordance with a position of the edge region.

According to an embodiment of the present disclosure, after sensing the touch start position and drag of the checkbox, the method may further include sensing another drag, and scrolling content in accordance with the other drag.

According to an embodiment of the present disclosure, displaying the selection of the content in the checkboxes between the touch start position and the touch release position may include displaying the selection of the content in checkboxes corresponding to a line connecting the touch start position and the touch release position.

According to embodiment of the present disclosure, displaying the selection of the content in the checkboxes between the touch start position and the touch release position may include determining a set region having as diagonal line connecting the touch start position and the touch release position, and displaying the selection of the content in checkboxes comprised in the set region.

According to an embodiment of the present disclosure, after the operation of displaying the checkboxes for the respective content, the method may further include activating a multi selection mode.

According to an embodiment of the present disclosure, activating the multi selection mode may include sensing the selection of an icon and activating the multi selection mode.

According to an embodiment of the present disclosure, activating the multi selection mode may include sensing a touch on a checkbox corresponding to content for a threshold time or more and activating the multi selection mode.

According to an embodiment of the present disclosure, after displaying the selection of the content in the checkboxes between the touch start position and the touch release position, the method may further include inactivating the multi selection mode.

Each of the above-described elements of the electronic device according to an embodiment of the present disclosure may be comprised of one or more elements, and the names of the elements may vary according to the kind of electronic device. The electronic device according to an embodiment of the present disclosure may include at least one of the above-described elements, and some of the elements may be omitted or an additional element may be further included. In addition, some of the elements of the electronic device may be combined into a single entity, and may perform the same functions as those of the elements before being combined.

The term “module” as used herein refers to a unit including one of hardware, software, and firmware, or a combination of two or more of them. For example, the term “module” may be used interchangeably with terms like unit, logic, logical block, component or circuit. The “module” may be a minimum unit of an integrally configured part or a part of it. The “module” may be a minimum unit that performs one or more functions or a part of it. The “module” may be implemented mechanically or electronically. For example, the “module” may include at least one of an Application

Specific Integrated Circuit (ASIC) chip, Field Programmable Gate Arrays (FPGAs), and a programmable logic device which performs any operation that is already well known or will be developed in the future.

At least part of the apparatus (for example, modules or functions) or method (for example, steps or operations) according to an embodiment of the present disclosure may be implemented by using instructions stored in a computer-readable storage media in the form of a programming module. When the instructions are executed by one or more processors (for example, the processor 120), the one or more processors may perform a function corresponding to the instructions. The computer-readable storage media may be the memory 130.

Examples of the computer-readable recording medium include hard disks, floppy disks, magnetic media such as magnetic tapes, optical media such as Compact Disc Read Only Memories (CD-ROMs and Digital Versatile Discs (DVDs), magneto-optical media such as floptical disks, and hardware devices such as Read Only Memories (ROMs), Random Access Memories (RAMs) and flash memories. Examples of the program commands include machine language code created by a compiler, and high-level language code that can be executed by a computer using an interpreter. The above-described hardware devices may be configured to operate as one or more software modules for performing operations of an embodiment of the present disclosure, and vice versa.

A module or programming module according to an embodiment of the present disclosure may include one or more of the above-described elements, may omit some elements, or may further include additional elements. The operations performed by the module, the programming module, or the additional elements may be performed in serial, in parallel, repeatedly, or heuristically. In addition, some operation may be performed in a different order or may be omitted, and additional other operations may be added.

According to an embodiment of the present disclosure, an electronic device may efficiently manage content by multi selecting content using a drag in a touch based input device.

While the disclosure has been shown and described with reference to certain preferred embodiments thereof, it will be understood by those skilled in the art that various changes in form and details may be made therein without departing from the spirit and scope of the disclosure as defined by the appended claims and equivalents thereof.

What is claimed is:

1. A method of operating an electronic device, the method comprising:
displaying checkboxes for respective content;
sensing a touch start position and drag of the checkbox;
sensing a touch release position of a checkbox of other content; and
displaying a selection of content in checkboxes between the touch start position and the touch release position.

2. The method of claim 1, further comprising:
after sensing the touch start position and drag of the checkbox,
sensing holding of the drag in a set edge region; and
scrolling content in accordance with the holding of the drag.

3. The method of claim 2, wherein scrolling the content in accordance with the holding of the drag comprises determining a scroll direction of the content in accordance with a position of the edge region.

4. The method of claim 1, further comprising:
after sensing the touch start position and drag of the checkbox,
sensing another drag; and
scrolling content in accordance with the other drag.

5. The method of claim 1, wherein displaying the selection of the content in the checkboxes between the touch start position and the touch release position comprises displaying the selection of the content in checkboxes corresponding to a line connecting the touch start position and the touch release position.

6. The method of claim 1, wherein displaying the selection of the content in the checkboxes between the touch start position and the touch release position comprises:
determining a set region having a diagonal line connecting the touch start position and the touch release position; and
displaying the selection of the content in checkboxes comprised in the set region.

7. The method of claim 1, wherein after displaying the checkboxes for the respective content, further comprising activating a multi selection mode.

8. The method of claim 7, wherein the multi selection mode is activated if selection of an icon is sensed.

9. The method of claim 7, wherein the multi selection mode is activated if a touch on a checkbox corresponding to content is held for a threshold time or more.

10. The method of claim 7, wherein after displaying the selection of the content in the checkboxes between the touch start position and the touch release position, further comprising inactivating the multi selection mode.

11. An electronic device comprising:
a display; and
at least one processor operatively connected to the display,
wherein the processor is configured to control the display to display checkboxes for respective content, sense a touch start position and drag of the checkbox, sense a touch release position of a checkbox of other content, and display a selection of content in checkboxes between the touch start position and the touch release position.

12. The electronic device of claim 11, wherein, after sensing the touch start position and drag of the checkbox, the processor is configured to sense holding of the drag in a set edge region, and scroll content in accordance with the holding of the drag.

13. The electronic device of claim 12, wherein the processor is configured to determine a scroll direction of the content in accordance with a position of the edge region.

14. The electronic device of claim 11, wherein, after sensing the touch start position and drag of the checkbox, the processor is configured to sense another drag, and scroll content in accordance with the other drag.

15. The electronic device of claim 11, wherein the processor is configured to display the selection of the content in checkboxes corresponding to a line connecting the touch start position and the touch release position.

16. The electronic device of claim 11, wherein the processor is configured to determine a set region having a diagonal line connecting the touch start position and the touch release position, and display the selection of the content in checkboxes comprised in the set region.

17. The electronic device of claim 11, wherein, after displaying the checkboxes for the respective content, the processor is configured to activate a multi selection mode.

18. The electronic device of claim 17, wherein, if a selection of an icon is sensed, the processor is configured to activate the multi selection mode.

19. The electronic device of claim 17, wherein, if a touch on a checkbox corresponding to content is held for a threshold time or more, the processor is configured to activate the multi selection mode.

20. The electronic device of claim 17, wherein, after displaying the selection of the content in the checkboxes between the touch start position and the touch release position, the processor is configured to inactivate the multi selection mode.
